(19) United States
(12) Patent Application Publication
(10) Pub. No.: US 2004/0199591 A1
(43) Pub. Date: Oct. 7, 2004

(54) Portable electronic mailbox

(76) Inventor: Chao-Shu Ho, Pa-Te City (TW)

Correspondence Address: Jason Z. Lin, Suprime Patent Sevices, Post Office Box 2339, Saratoga, CA, 95070-0339, US

(21) Appl. No.: 10/407,684

(22) Filed: Apr. 5, 2003

(51) Int. Cl. G06F 15/16; G06F 9/00

(52) U.S. Cl. 709/206; 713/100

(57) ABSTRACT

A portable electronic mailbox operates through a carry-on disk comprising a circuit board, a flash memory, a flash-memory control chip, and a USB interface. Mailbox software stored in the flash memory is communicable with a computer via the USB interface of the carry-on disk for fetching-in a user's mail account number, mail folder, and/or address book or fetching-out the carry-on disk to thereby provide an e-mail receiving/transmitting firmware.

### BACKGROUND OF THE INVENTION

1. Field of the Invention

The present invention relates generally to an electronic mailbox, and specifically to a portable electronic mailbox.

2. The Prior Arts

E-mail is undoubtedly one of the most popular communication ways today. However, it is still inconvenient for transmitting or receiving an e-mail under some specific situations, particularly when privacy and volume of mailbox is considered.

Since transmitting or receiving e-mails is usually made through Microsoft Outlook Express or an electronic mailbox so far, a user might have hitches or probably feel uneasy in doing it on a computer other than his own one. Therefore, rooms are there for improvements in this matter.

### SUMMARY OF THE INVENTION

A primary object of the present invention is to provide a portable electronic mailbox via coordination of software and hardware.

According to the present invention, the mailbox operates through a “carry-on disk”, which constitutes a portable memory device comprising a circuit board, a flash memory, a flash-memory control chip or hard drive, and a USB (universal serial bus) interface. Mailbox software of the present invention stored in the flash memory is communicable with a computer via the USB interface of the carry-on disk for fetching-in a user's mail account number, mail folder, and/or address book or fetching-out the carry-on disk to thereby provide an e-mail receiving/transmitting operation system.

The mailbox software of the present invention is composed of a TSR (terminate-and-stay-resident) program, a tool and a main program, in which the TSR program is provided for detecting whether the carry-on disk is inserted in a computer or not. The tool program is applied for checking whether a user's account is valid or not. The main program is to fetch in or out a mail folder or address book of the carry-on disk.

When using the present invention is desired, a user inserts the carry-on disk in a computer, and automatically, the mailbox software communicates with the computer via the USB interface and fetches the user's mail account number, mail folder, and address book in and/or out the carry-on disk. This realizes a thin and light portable electronic mailbox of the present invention for receiving and/or transmitting e-mails effectively.

For more detailed information regarding advantages or features of the present invention, at least an example of preferred embodiment will be described below with reference to the annexed drawings.

### BRIEF DESCRIPTION OF THE DRAWINGS

The related drawings in connection with the detailed description of the present invention to be made later are described briefly as follows, in which:

FIG. 1 is a schematic view of a carry-on disk in accordance with the present invention, as well as a computer to which the carry-on disk can be inserted; and

FIG. 2 is a flowchart of a portable electronic mailbox of the present invention.

### DETAILED DESCRIPTION OF THE PREFERRED EMBODIMENT

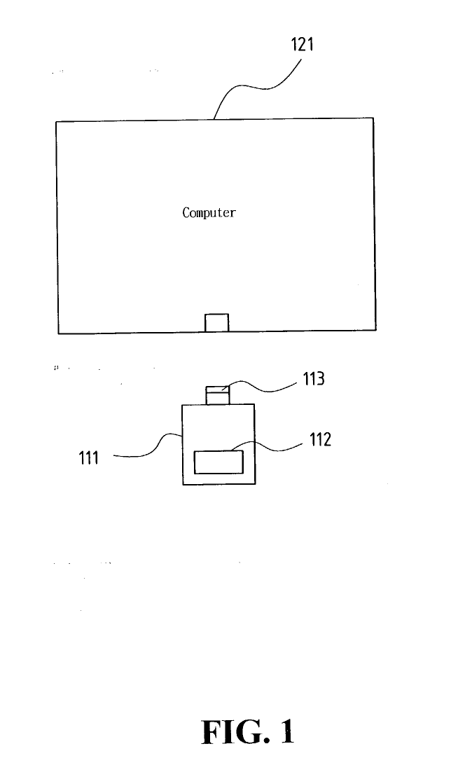

The present invention relate to a portable electronic mailbox to be used through a user's carry-on disk. As indicated in FIG. 1, the user's carry-on disk 110 comprises a circuit board 111, a flash-memory control chip 112, a flash memory 113, and a USB (universal serial bus) interface 114. If desired, a hard drive can be additionally or alternatively incorporated.

The present invention is practiced by preparing mailbox software and installing the software in the flash memory 113 of the carry-on disk 110. After the carry-on disk 110 is electrically coupled to a computer 21, the software communicates with the computer 121 via the USB interface 114 of the carry-on disk 110 and activates Microsoft Outlook Express on Windows Platform for transmitting or receiving operation of e-mails.

The computer 121 can be any type of computers, such as a desktop computer and a notebook computer, and Windows Platform can be any of Windows 95, Windows 98, Windows Me, Windows 2000, or Windows XP.

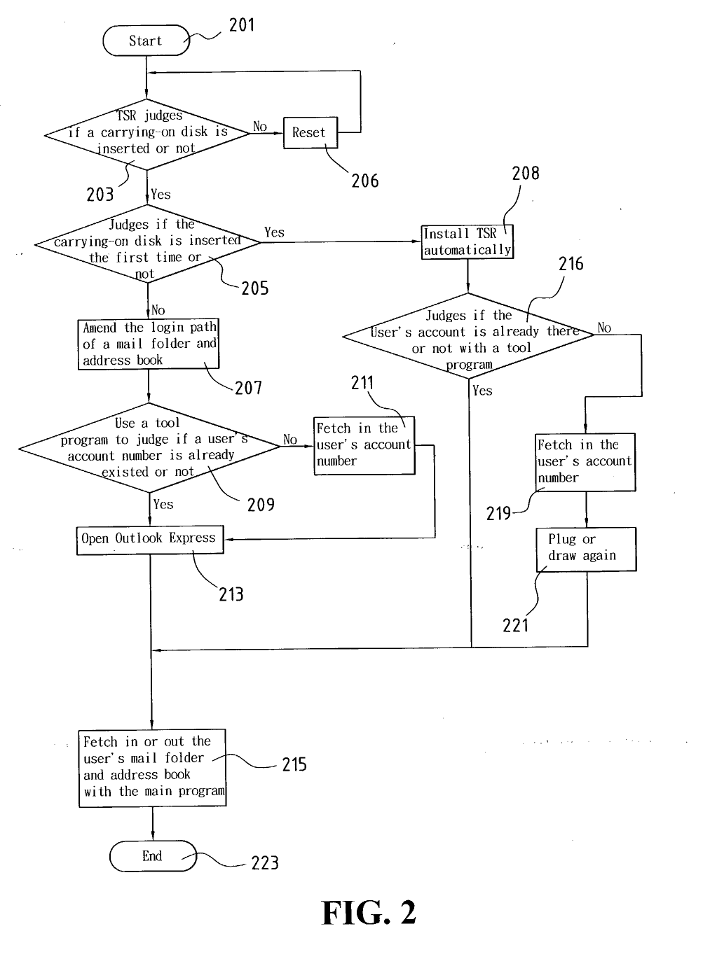

FIG. 2 is a flowchart of a portable electronic mailbox of the present invention. As illustrated in FIG. 2, after the carry-on disk 110 is inserted in the computer 121, the mailbox software stored in the carry-on disk 110 proceeds the following procedure:

A step 201 for starting the operation; a step 203 for executing a terminate-and-stay-resident (TSR) program to make sure whether the carry-on disk 110 has been inserted in the computer 121 or not; a step 206 for resuming the step 203 to execute the TSR program again if negative, or a step 205 for checking whether the insertion of the carry-on disk 110 is the first time or not otherwise; and a step 207 for amending the login path of a mail folder or an address book if negative, or a step 208 for installing a TSR program otherwise.

Following the step 207, the software performs a step 209 for executing a tool program to check whether a user's account is valid or not; a step 213 for opening the Outlook Express if positive, or a step 211 for the tool program in the step 209 to install a necessary driver to fetch a user's mail account number otherwise; then, a step 213 for activating the Outlook Express; and a step 215 for proceeding the main program to fetch in or fetch out the user's mail folder or address book.

After the above step 208 for installing a TSR program to hence install a driver, the software is to proceed: a step 216 for executing a tool program to judge whether a user's account is established or not; then, a step 215 for executing the main program if positive, or a step 219 for the tool program in the step 216 to install a necessary driver then fetch the user's mail account number otherwise; and a step 221 for plugging or drawing again and returning to the step 215 for executing the main program.

After the step 215 for executing the main program is finished, all the user has to do is draw the carry-on disk 110 out of the computer 121, then a step 223 for ending and resetting will be performed automatically.

In the above described, at least one preferred embodiment has been described in detail with reference to the drawings annexed, and it is apparent that numerous changes or modifications may be made without departing from the true spirit and scope thereof, as set forth in the claims below.

What is claimed is:

1. A portable electronic mailbox, operating through a carry-on disk comprising a circuit board, a flash memory, a flash-memory control chip, and a USB (universal serial bus) interface, in which a mailbox software stored in the flash memory is communicable with a computer via the USB of the carry-on disk to hence fetch in or out a user's mail account number, mail folder, or address book by a method comprising the following steps:
(a) executing a TSR (terminate-and-stay-resident) program to detect whether the carry-on disk is inserted in a computer or not; if positive, executing step (b), or reset and resume the TSR program;
(b) executing a tool program to check after insertion of the carry-on disk is confirmed whether a user's mail account number is already existed in the carry-on disk or not; if positive, activating Microsoft Outlook Express and proceeding to step (c), otherwise, installing a necessary driver and fetching in a user's mail account number, then proceeding step (c); and
(c) executing automatically a main program for fetching in or out the user's mail folder or address book after activating the Outlook Express is confirmed.

2. The portable electronic mailbox according to claim 1, wherein the method further comprises steps of starting, for checking whether the carry-on disk is inserted in a computer or not, for judging whether the carry-on disk is inserted the first time or not, and for resetting in addition to executing the TSR program, the tool program, and the main program, in which the carry-on disk is inserted no sooner than the step for starting is executed automatically, then the TSR program is executed to check whether the carry-on disk is really inserted in a computer or not; if positive, judging whether the carry-on disk is inserted the first time or not; if negative, resetting and resuming the TSR program.

3. The portable electronic mailbox according to claim 2, wherein if the step of judging whether the carry-on disk is inserted the first time or not comes out to be negative, then executing a step for amending the login path of mail folder or address book, if positive, installing a TSR and hence a necessary driver.

4. The electronic mailbox according to claim 3, wherein if the step of executing the tooling program to judge whether a user's mail account is existed or not comes out to be positive, then activating Outlook Express, otherwise installing a necessary driver and fetching a user's mail account number, then executing Outlook Express.

5. The electronic mailbox according to claim 4, wherein after activating Outlook Express, the method is to execute the main program for fetching in or out the user's mail folder or address book.

6. The electronic mailbox according to claim 3, wherein after the step of installing the TSR program automatically, a following step goes to execute the tool program for judging whether a user's account number is already existed or not; if positive, then the method is to run the main program, otherwise, the tool program is supposed to install a necessary driver, then fetching a user's mail account number and swapping programs or data between the carry-on disk and memory, then executing the main program.

7. The electronic mailbox according to claim 1, wherein after the main program of the method is finished, all a user has to do is draw the carry-on disk out of the computer, and the method resets to restore the original settings and end the operation.

8. The electronic mailbox according to claim 1, wherein the computer communicable with the electronic mailbox software through the USB interface of the carry-on disk is a desktop computer.

9. The electronic mailbox according to claim 1, wherein the computer communicable with the electronic mailbox software through the USB interface of the carry-on disk is a notebook computer.

10. The electronic mailbox according to claim 1, wherein the electronic mailbox software communicable with a computer through the USB interface of the carry-on disk is capable of fetching in or out a user's mail account number, mail folder, or address book by taking advantage of the Windows platform.
